(19) United States
(12) Patent Application Publication
(10) Pub. No.: US 2016/0312679 A1
(43) Pub. Date: Oct. 27, 2016

(54) Engine Exhaust System Decomposition Tube

(71) Applicant: Nelson Global Products, Inc., Stoughton, WI (US)

(72) Inventors: Rob Schellin, Stoughton, WI (US); Jason Drost, Lake Mills, WI (US); Jason Goetz, Fitchburg, WI (US)

(21) Appl. No.: 14/694,858

(22) Filed: Apr. 23, 2015

(51) Int. Cl. F01N 3/28; B01D 53/94

(52) U.S. Cl. CPC F01N 3/2803; B01D 53/9431

(57) ABSTRACT

A reductant decomposition reactor for use in exhaust systems and a method for making the same are provided, wherein the reactor includes a unitary tube portion formed with a reductant injector mount and a mixer mounted therein. The mixer fits in a seamless tube portion and is configured to enhance a reductant and an exhaust stream.

### FIELD AND BACKGROUND OF THE INVENTION

The present invention relates to the field of exhaust systems and more particularly to a decomposition reactor with a unitary tube portion supporting a mixer for use in an exhaust system.

A common problem associated with the use of internal combustion engines is the formation of undesirable by-products found in the exhaust stream, particularly nitrogen-oxides. Aftertreatment systems, such as selective catalytic reaction (SCR) systems, are used to lower the nitrogen-oxide content in the exhaust stream using urea and a reduction catalyst. In some SCR systems a urea decomposition reactor with a mixer is used to promote the decomposition of the urea into ammonia.

While decomposition reactors within SCR systems are known, conventional decomposition reactors are typically formed in multiple parts that are relatively expensive to manufacture, assemble, and maintain. For example, any location in a reactor, such as a connecting joint in the tube, is a location where urea deposits can build up. Such a build-up reduces efficiency and can lead to failure.

Despite the problems with multi-tube reactors, known reactors are formed in multiple components so that an injector mount and a mixer can be mounted at a central location that is spaced apart from both the inlet and the outlet. This location is necessary because urea is injected into the central portion of the reactor, and the mixer must be located in the flow paths of the reduction catalyst and the exhaust. The need for a reductant mixer to be at a location adjacent to a reductant injector requires a multi-component decomposition reactor design that permits welding a mixer mount directly to the reactor tube in the central portion of the tube. Welding or otherwise installing the mixer mount at such a location has been done by using multi-piece construction. Further, welding the mixer directly to the reactor is undesirable because the mixer and reactor tube are usually made of different types of stainless steel that can be difficult to create a reliable weld.

In at least one prior method of assembly, a longitudinally split tube is used to enable welding of the mixer mount in one of the tube halves before the tube halves are assembled. In another design, an injector mount is incorporated into a relatively short section of a tube before being assembled with an inlet tube and an outlet tube to create a three-piece reactor, such as illustrated as item 105 in FIG. 8. These short sections are formed using standard tubing or by casting and thus welded together.

If a tube the full size of the reactor were used, welding mixers or mount brackets in place would be impractical because the distance from the mixer mount to the reactor inlet and outlet makes welding at the proper location impractical. Thus, there is a need for an improved reductant composition reactor with a mixer.

### SUMMARY OF THE INVENTION

The present invention is directed to both a method for making a reductant decomposition reactor, and a reductant decomposition reactor for use in exhaust systems that overcome problems associated with multi-component decomposition reactors and manufacturing methods. The invention also results in a smoother and cleaner interior surface at locations where contaminates can accumulate to improve operation and efficiency.

A reactor in accordance with the present invention includes a unitary tube having a central tube portion formed with an inlet and an outlet, a reductant injector mount joined to the central tube portion, and a mixer mounted in the central tube portion and spaced apart from the outlet. The inlet is formed at a first end of the central tube portion and is configured to create a sealed connection to an exhaust system. The outlet is formed at a second end of the central tube portion and is configured to create a sealed connection to a downstream portion of the exhaust system. No transverse joints, longitudinal splits, or otherwise segmented tube portions for installing a mixer or mixer mount are necessary.

The reductant injector mount can include an integral tube section that is part of the unitary tube. The reductant injector mount is configured to sustain high temperatures and relatively high velocity exhaust flow at the inner surface of the injector mount to reduce the formation of reductant deposits. By including the injector mount as part of the unitary tube structure, costs are further reduced, while flow and performance characteristics are further improved. Such a tube formation method is possible using hydroforming methods, for example.

The mixer fits in the central tube portion and is arranged and configured to reduce reductant build-up inside the central tube portion, and to cause turbulence in exhaust and reductant flows that enhances decomposition of the exhaust stream. The mixer is positioned upstream and spaced apart from the outlet in the unitary tube and can be maintained in place by a bracket, crimp, step, or other locating structure that can be formed when the tube is formed.

The outlet can be formed and sized during manufacturing after the mixer is installed because the outlet will typically have a smaller diameter than the mixer and the central tube portion. Nonetheless, the unitary structure of the reactor can reduce costs and improve performance of the decomposition tube reactor.

The reactor further can include an insulating layer surrounding an outer surface of the central tube portion and the reductant injector mount. The insulation layer retains heat within the reactor to promote decomposition of reductant and to mitigate the formation of reductant deposits on interior walls of the reactor.

The unitary tube decomposition reactor can be manufactured by: forming a unitary tube defining an exhaust passage, and having an inlet, a central portion downstream from the inlet, and an outlet downstream from the central portion; and a reductant injector mount defining a reductant flow passage in fluid communication with the exhaust passage; shaping the central portion to define a mixer mount location; installing a mixer at the mixer mount location; and shaping the outlet.

The forming step can be performed by hydroforming the unitary tube using a fluid material under pressure inside a tube blank to force the blank outwardly against a die in the appropriate shape. The step of shaping the central portion to define a mixer mount location can be performed by crimping the central portion.

Other features and benefits of the present invention are described below.

### BRIEF DESCRIPTION OF THE DRAWINGS

FIG. 1 is a perspective view of a reductant decomposition reactor of the present invention;

FIG. 2 is a side view of a reductant decomposition reactor having a different shape than the reactor of FIG. 1 and with a doser mount joined to an injector mount portion of the decomposition reactor;

FIG. 3 is a side view of the reductant decomposition reactor of FIG. 2;

FIG. 4 is a perspective cross-sectional view of a middle tube portion of the detachable reductant decomposition reactor of FIG. 2;

FIG. 5 is a side cross-sectional view of the reductant decomposition reactor of FIG. 2;

FIG. 6 is a partial cross-sectional view of the decomposition reactor at a mixer mount location;

FIG. 7 is another embodiment of the present invention in which the central portion of the reactor includes an elbow; and

FIG. 8 is a side cross-sectional view of a prior art decomposition reactor.

### DETAILED DESCRIPTION OF THE DRAWINGS

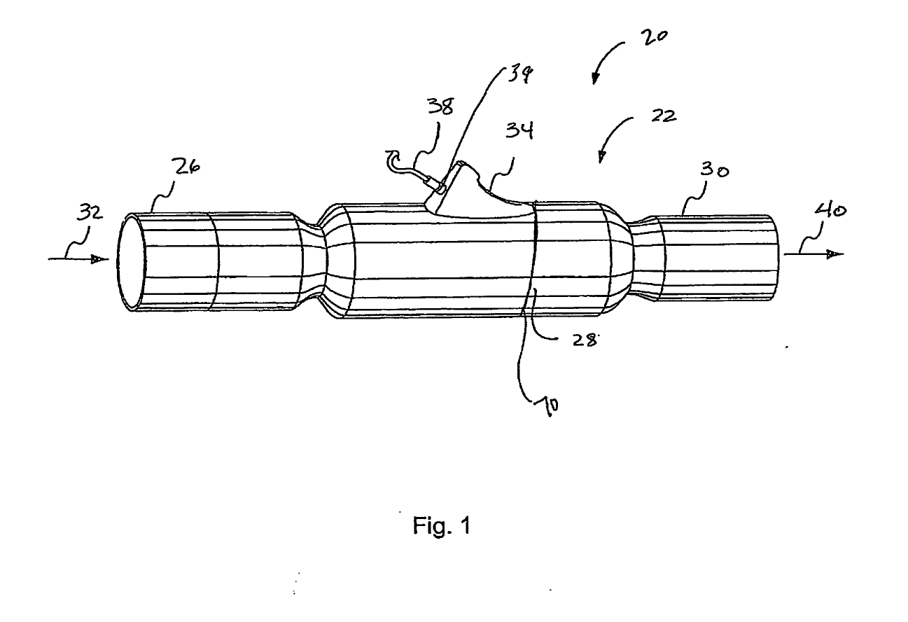

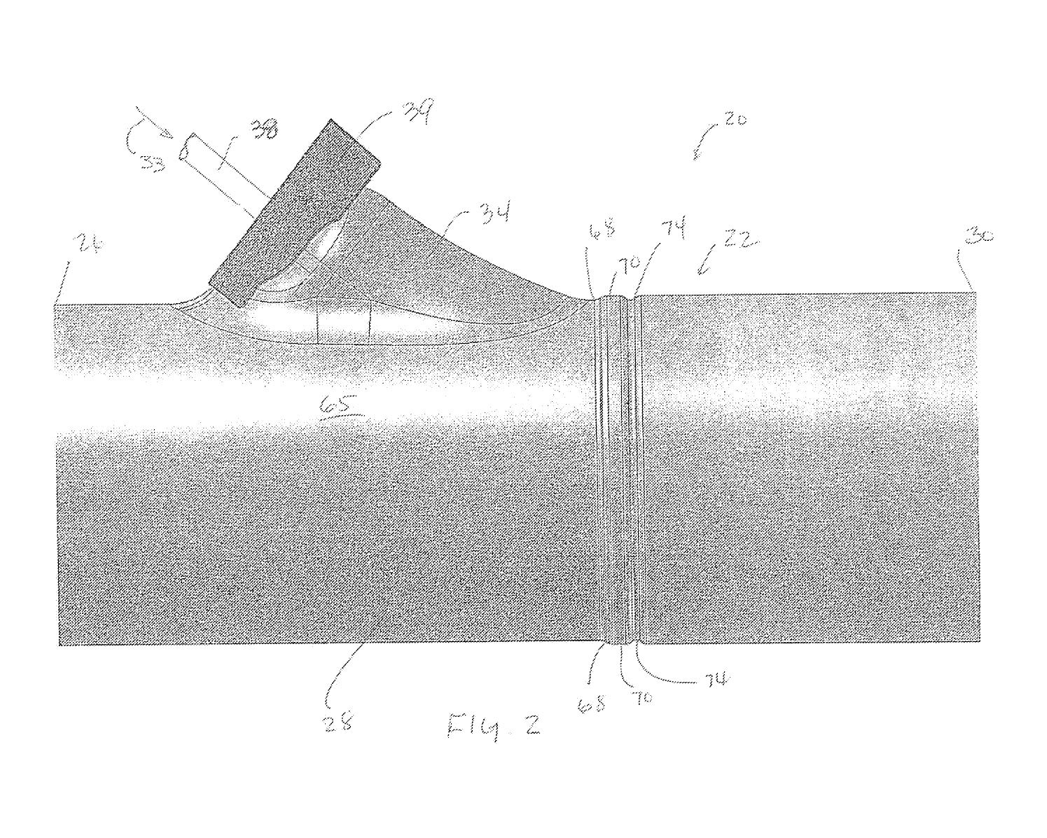

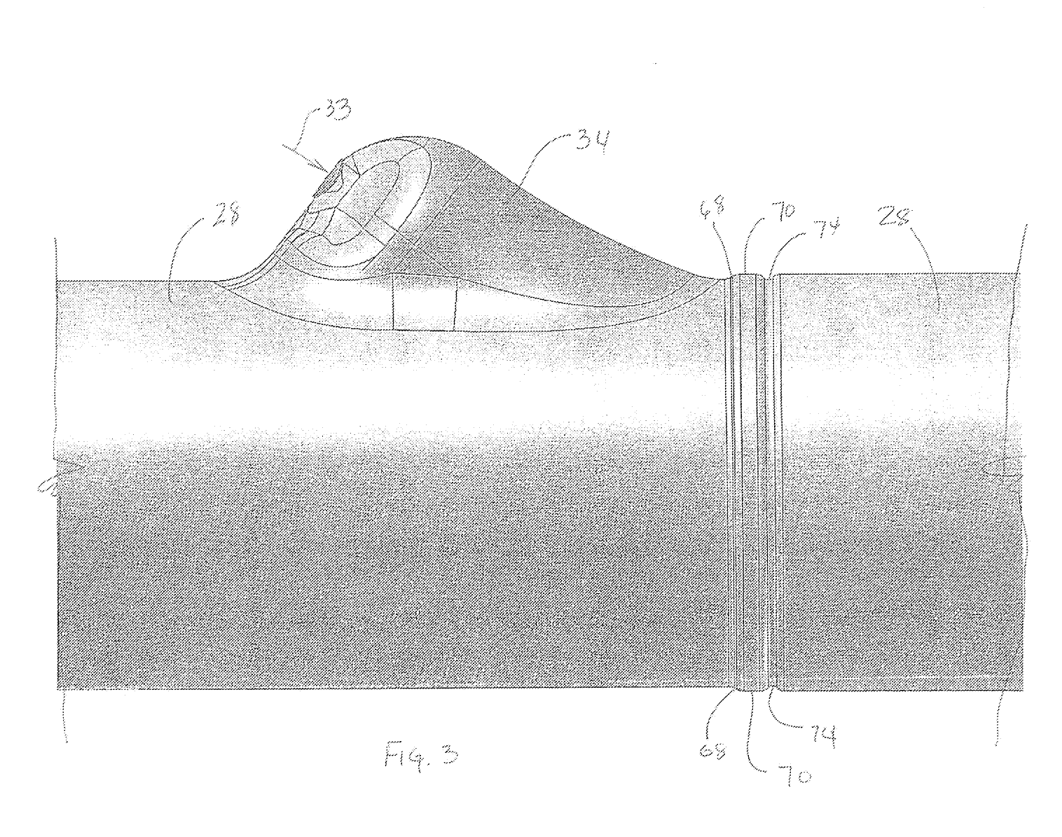

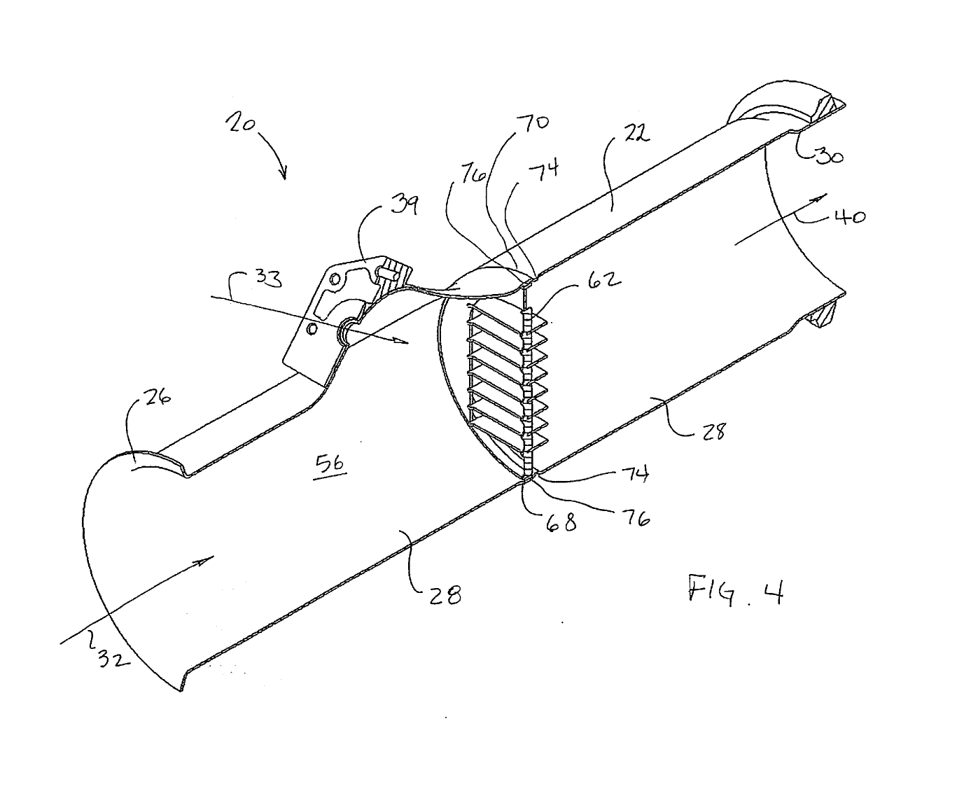

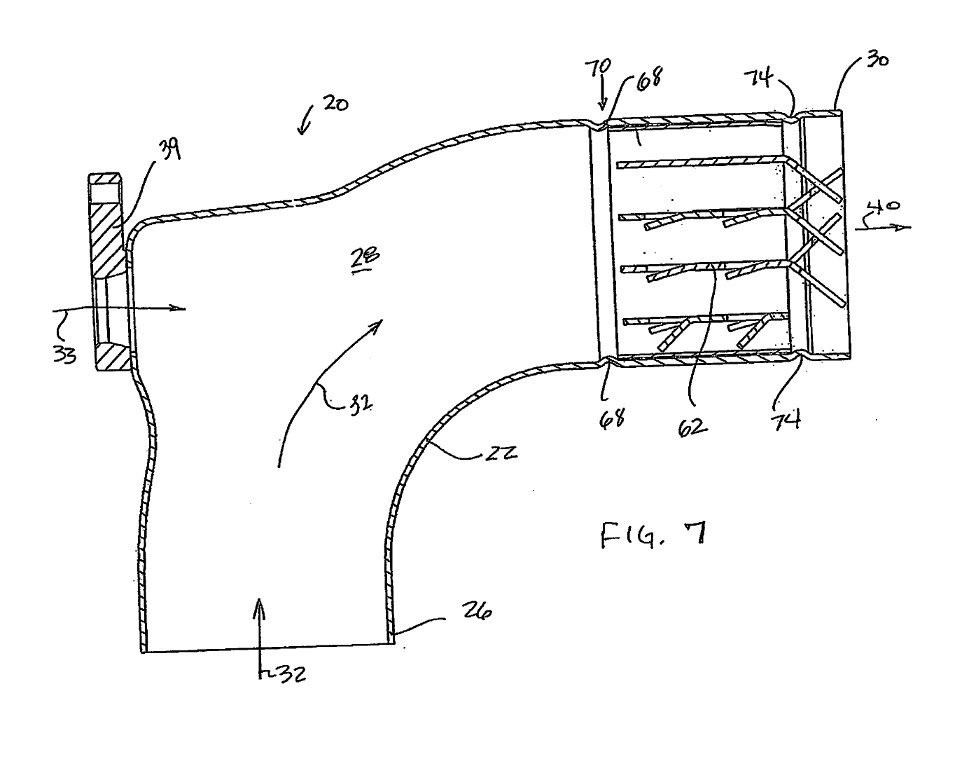

In the following detailed description, reference is made to the accompanying drawings wherein the same reference numeral will be used to identify the same or similar element in each of the figures. Illustrated in FIGS. 1 through 6, is an exhaust aftertreatment system 20, in accordance with the present invention, that is intended to be positioned between an engine (not illustrated) and a tailpipe (also not illustrated). The system 20 is secured to an engine or related support device, and must withstand high temperatures, vibrations, and other harsh conditions. FIG. 7 illustrates an alternate embodiment of an exhaust aftertreatment system 20 having an elbow shape, but otherwise similar to the embodiment of FIGS. 1 through 6.

The exhaust aftertreatment system 20 includes a decomposition reactor 22 that is a unitary tube and with inlet 26, a central decomposition portion 28, an outlet 30, and a reductant injection portion 34. Generally, exhaust gas flows from the engine, as indicated by arrow 32, enters the inlet 26 and flows into the central decomposition portion 28 where it is mixed with a reductant that is injected from a reductant injector 38 mounted on a doser mount 39. The reductant is provided from a supply source (not illustrated) into the decomposition portion 28 in a direction indicated by arrow 33 at appropriate rates and temperatures. Decomposed exhaust exits the exhaust aftertreatment system 20 through the outlet 30, as indicated by exhaust arrow 40. Further, the shape of the reactor 22 in FIG. 1 includes portions 29 of reduced diameter between the central decomposition portion 28, and the inlet 26 and the outlet. Portions 29 act as venturis, but these are optional features and are not included in the other illustrated embodiments.

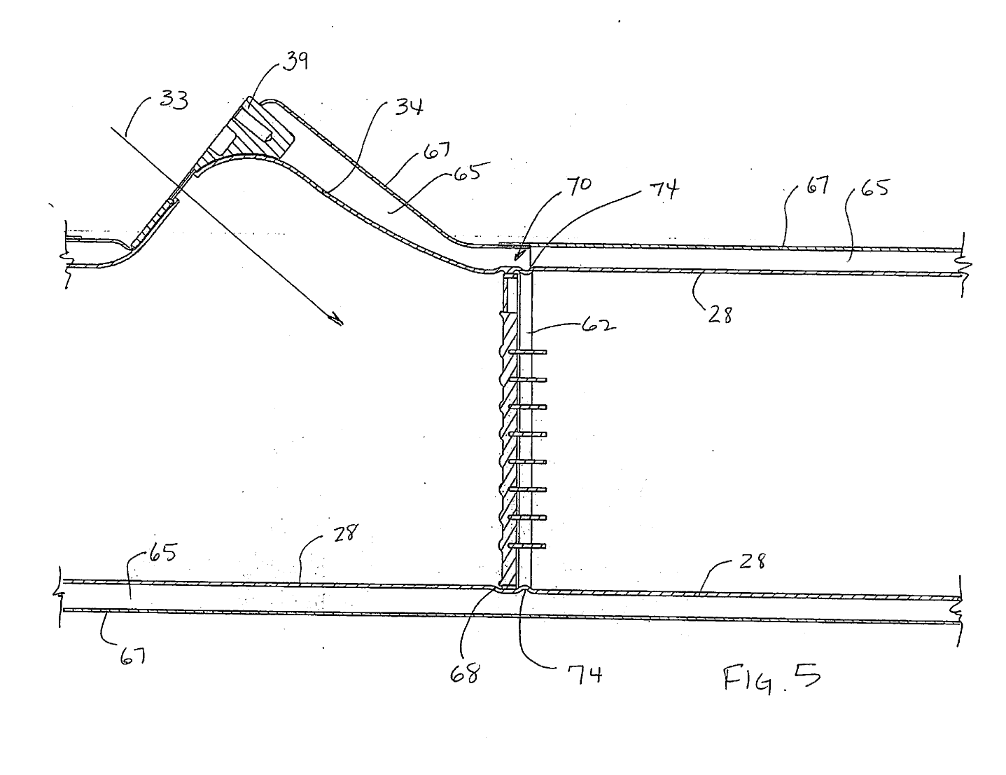

As viewed in FIGS. 1 through 6, the reductant injection portion 34 is preferably shaped and insulated as described in pending U.S. application Ser. No. 14/467,907, filed in the United States Patent and Trademark Office on Aug. 15, 2014, and incorporated herein by reference. As seen in FIG. 5, an insulation layer 65 surrounded by foil 67 is used to maintain high temperatures inside the decomposition reactor 22.

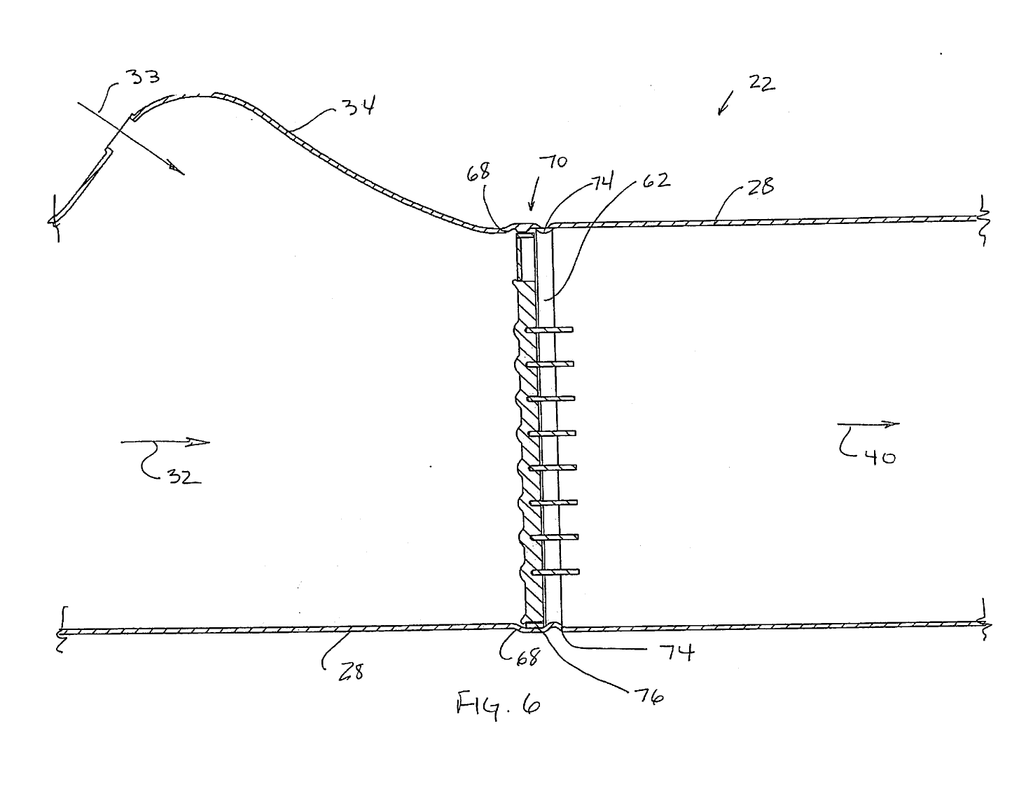

As seen in the cross section illustrated in FIGS. 5 and 6, the exhaust aftertreatment system 20 includes the components described above including the decomposition reactor 22 which is a unitary (one-piece) tube having the inlet 26, the central decomposition portion 28, the outlet 30, and the reductant injection portion 34. As seen in the cross-section, the decomposition portion 28 defines an exhaust passage 56 extending from the inlet end 26 and downstream through the central decomposition portion 28, and out of the outlet 30, as indicated by the arrows 32, 40, and with no joints, splits, or tube segments included.

The inlet 26 and the outlet 30 can be formed in any desired shape, as depicted in the figures, and dimensioned to mate with related components. For example, the inlet 26 and the outlet 30 can have: reduced diameters, expanded diameters, bends or elbows, slots, or any other shapes, as required.

The reductant injector 38 is disposed at an angle to the central decomposition portion 34 to maintain optimum exhaust gas flow rates, but in the illustrated embodiments, it is directed (arrow 33) toward an opposite wall of the central decomposition portion 28. To reduce the amount of reductant collecting in the opposite side of the central decomposition portion 34, a mixer 62 is positioned in the path of the reductant flow 33, as disclosed in U.S. Pat. No. 8,240,137, for example. Other diffusers and dispersers can be included, as well, and mounted using the features of the present invention. See: U.S. Pat. No. 8,240,137, for example.

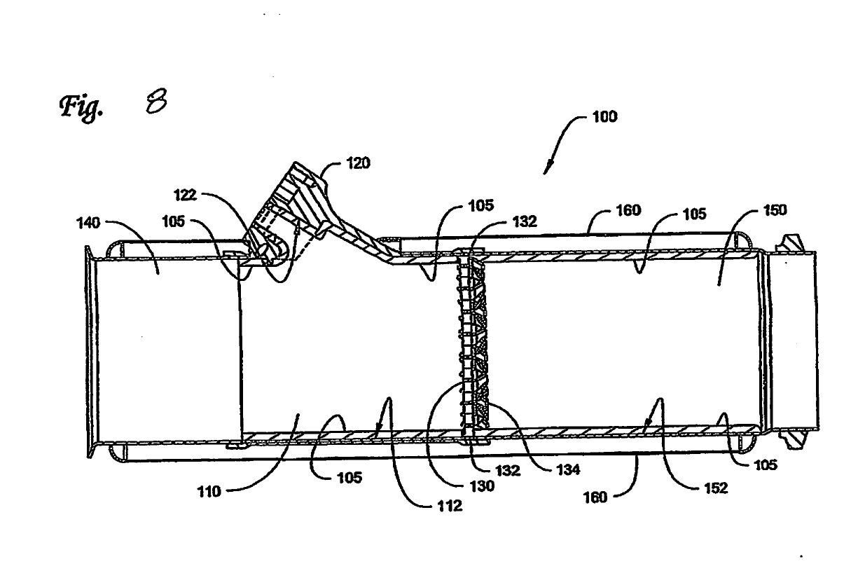

As best seen in FIGS. 5 and 6, the central decomposition portion 28 is made of a single tube, as opposed to multi-tube components. The central portion 28 of the reactor 22 can be of any shape and can include an elbow, as seen in FIG. 7, for example. A multi-piece design is illustrated in the prior art drawings of FIG. 8, for ease of comparison.

The central tubular decomposition portion 28 is preferably formed with a step 68 used to define a mixer location 70 at which the mixer 62 will be located and fixed in place. The step 68 can prevent the mixer 62 from being inserted in the tube 22, but not beyond the step 68 during assembly, and can restrain the mixer 62 from movement during use. Other mixer 62 placement devices can be used to located and restrain the mixer 62.

The step 68 is preferably formed upstream from the mixer location 70 and then further restrained downstream by a crimp 74 that is made after the mixer 62 is installed from the outlet end 30. If desired, the step 68 can be formed downstream from the mixer 62, with the mixer 62 being installed from the inlet 26, and the crimp 74 formed upstream from the mixer 62. The crimp 74 can be offset from the mixer 62 to trap the mixer 62 against the step 68 or the crimp 74 can be directed onto the mixer 62.

The central portion 28 can have any desired cross sectional shape such as round, oval or other shape to optimize exhaust flow. The central portion 28 has a slightly out-of-round shape to match a similarly shaped mixer 62, so that the mixer 62 is properly oriented. Alternatively, the central portion 28 can include embossments 76 that are “clocking features” to engage slots in the mixer 62. The embossments 76 can be formed at asymmetrical locations so that only mixer slots at those same locations will mate with the embossments to ensure proper mixer 62 orientation, and can be shaped so that the mixer 62 cannot be installed backwards.

Due to the forces, vibrations, and temperatures imposed on the exhaust after-treatment system 20, the mixer 62 must be precisely positioned and maintained in that position for proper operation of the decomposition reactor 22. In a unitary tubular arrangement such as in the present invention, defining the mixer location 70 and mounting the mixer 62 in place can be done in a number of other ways, but due to the spacing of the mixer location 70 from both the inlet 26 and the outlet 30, it can be prohibitively difficult and expensive to provide a bracket or other structure at such a location, and further to weld a mixer mount in such a place.

The mixer 62, shown in FIGS. 5 and 6, can be similar to the mixer described in U.S. patent application Ser. No. 12/237,574, filed on Sep. 25, 2008, directed to a “Reductant Decomposition Mixer And Method For Mading The Same”. As stated above, the mixer 62 can be housed within the unitary tube 22 using a floating fit between the step 68 and the crimp 74 or be restrained by the crimp 74 directly on the mixer 62. Both arrangements permit placement of the mixer 62 into the reactor 22 without welding or casting.

Preferably, the central decomposition reactor 22 is formed by hydroforming, for example, but other methods can be used. Generally in preferred embodiments, the reactor 22 is formed by inserting a flexible medium, such as a fluid, elastomer, or gas into a tube, blank and pressurizing the flexible medium to force the tube blank outwardly into contact with a die in the shape of the decomposition reactor 22. The flexible medium can be used at ambient temperature or heated to improve the expansion force and malleability of the tube blank.

Preferably, the reactor 22 is formed to include an integral reductant injector portion 34, but the reductant injector portion 34 can be attached after the unitary tube is formed. Also preferably, the mixer locating step 68 is formed in the same process as the tube forming step, but the step 68 can be formed in a separate manufacturing step, such as by crimping, for example.

After the central decomposition reactor 22 is formed, the mixer 62 is positioned against or adjacent to the mixer locating step 68, if used and the reactor 22 is crimped using known methods to grip directly on the mixer 62 or trap the mixer 62 between the crimp 74 and the step 70. Other steps for holding the mixer 62 in place can also be used.

As stated above, the mixer 62 and unitary reactor tube 22 are preferably shaped to permit only one orientation inside the reactor 22. Suitable methods include matching out-of-round shapes of the mixer 62 and the reactor 22, tapers, embossments 76 and slots, key ways, stops, and any other suitable method for ensuring the mixer is rotationally mating oriented properly within the reactor 22.

In another example, the mixer 62 can also include an asymmetric flat spot at a six o'clock position, for example, to ensure proper orientation with a mixer that includes a mating flat spot, thereby ensuring proper rotational orientation and/or preventing the mixer 62 from being inserted backwards into the unitary tube 22. Using the steps, crimping, shaping, and other features described allows the mixer 62 to fit within the central tube portion 28 without being welded or cast into place. Once the mixer 62 is mounted in place, the outlet 30 (or inlet 26) is formed using any desired method.

The elbow-shaped embodiment of FIG. 7 includes essentially the same elements described above, but is shaped to mate with a different exhaust system arrangement. The mixer 62 is an alternate mixer configuration, but cooperates with the reductant injector in much the same way as other embodiments described herein.

The embodiments presented herein are directed to a detachable reductant decomposition reactor with a mixer to be placed in a SCR exhaust system. The reactor includes a reductant injector mount that is configured to efficiently provide reductant into the SCR exhaust system, while avoiding the formation of reductant deposits within the reactor. The mixer 62 is oriented within the reactor 20 so as to be capable of causing decomposition of nitrogen-oxide reductant in the exhaust stream as the exhaust stream flows through the decomposition reactor 22. The reactor 22 also includes an insulating layer and heat shields to retain heat within the reactor in order to aid in the decomposition of the reductant and to mitigate the formation of reductant deposits.

In the illustrated embodiment the mixer 62 and the unitary tube 22 are preferably formed of stainless steel, such as series 300, 400, or 900, and more preferably AISI Type 439 stainless steel. This material has a high content of alloying materials that provide superior corrosion and erosion prevention characteristics when placed in a decomposition reactor or any similar environment that is highly corrosive and subject to high temperatures, and, cyclic temperatures, for example.

FIG. 8 is a side view of a prior art detachable reductant decomposition reactor 100 formed using a welding method. The reactor 100 includes a multi-piece tube assembly having a middle tube portion 110, a reductant injector mount 120, an inlet tube 140, and an outlet tube 150. The prior art reactor 100 also includes a mixer 130 placed between the outlet 150 and the middle tube portion 110, at a connection location with the outlet tube 150. In this type of reactor, a multi-component tube assembly is necessary so that the mixer 130 can be positioned near the reductant injector.

The multi-piece tube assembly includes the inlet tube 140, the middle tube portion 110, the outlet tube 150, and the injector mount 120. The middle tube portion 110 is formed separately from the injector mount 120 and they are welded together, thereby avoiding distortion in the reactor 100 that could result from welding an external injector mount to the middle tube portion 100. The inlet tube 140 and the outlet tube 150 are required to be separate components due to the need to install the mixer 130, as illustrated.

The mixer fits between the middle tube portion and the outlet tube and is configured to decompose the reductant in an exhaust stream. The injector mount comprises a tube like section that connects at a first end of the middle tube portion and at a second end to an injector port of the injector mount and is configured to create high temperature, high velocity exhaust flow at the inner surface of the injector mount to reduce the formation of reductant deposits.

In a multi-piece prior art assembly such as illustrated in FIG. 8, the middle tube portion 110, the mixer 130 and the outlet tube 150 are formed of the same material or materials with similar coefficients of thermal expansion. This allows the middle tube portion, the mixer 130 and the outlet tube 150 to have the same thermal expansion and contraction when the reactor 100 is used in an aftertreatment system.

It is to be understood that other embodiments may be utilized without departing from the spirit and scope of the claims. The previous detailed description is, therefore, not to be taken in a limiting sense

1. An exhaust aftertreatment system comprising:
a unitary tube decomposition reactor having:
an inlet;
a central portion downstream from the inlet;
an outlet spaced apart and downstream from the central portion;
and defining an exhaust passage extending from the inlet, through the central portion, and to the outlet; and
a reductant injector mount joined to the central portion and defining a reductant passage in fluid communication with the exhaust passage; and
a mixer disposed in the central portion of the unitary tube downstream from and adjacent to the reductant injector mount and upstream and spaced apart from the outlet.

2. The exhaust aftertreatment system of claim 1, wherein the mixer is joined to the unitary tube decomposition reactor at a crimp in the unitary tube decomposition reactor.

3. The exhaust aftertreatment system of claim 1, wherein the mixer has an outlet diameter that is larger than an inner diameter of the outlet.

4. The exhaust aftertreatment system of claim 1, wherein the unitary tube decomposition reactor is formed by hydroforming.

5. A method for forming a unitary tube decomposition reactor, the method comprising the steps of:
forming a unitary tube defining an exhaust passage extending from an inlet, a central portion downstream from the inlet, and an outlet spaced apart and downstream from the central portion;
joining to the unitary tube
a reductant injector mount defining a reductant flow passage in fluid communication with the exhaust passage;
shaping the unitary tube decomposition reactor at the central portion to define a mixer mount location;
installing a mixer at the mixer mount location; and
shaping the outlet.

6. The method for forming a unitary decomposition tube of claim 5, wherein the step of forming a unitary tube comprises the step of: hydroforming the unitary tube.

7. The method for forming a unitary decomposition tube of claim 5, wherein the step of shaping the unitary tube at the central portion comprises the step of: crimping the unitary tube decomposition reactor.

8. The method for forming a unitary decomposition tube of claim 5, wherein the mixer mount location is disposed downstream from the reductant injector mount.

9. The method for forming a unitary decomposition tube of claim 5, wherein the mixer mount location is upstream and spaced apart from the outlet.
